(19) United States
(12) Patent Application Publication
(10) Pub. No.: US 2006/0099304 A1
(43) Pub. Date: May 11, 2006

(54) Method of manufacturing shochu

(75) Inventor: Takeshi Shimoda, Kumamoto (JP)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Yamatoichi brewing company, Kumamoto (JP)

(21) Appl. No.: 10/531,724

(22) PCT Filed: Aug. 26, 2004
(86) PCT No.: PCT/IB04/02754

§ 371 Date: Apr. 18, 2005

(30) Foreign Application Priority Data
Aug. 29, 2003 (JP) 2003-307822

(51) Int. Cl. A23F 3/16

(52) U.S. Cl. 426/52

(57) ABSTRACT

This invention's method of manufacturing shochu consists of the following steps: (1) cultivating koji mold (Aspergillus oryzae) upon and into steamed rice, (2) making starter mash by fermenting a mixture of the koji mold, yeast seeds, and water, (3) making mash by fermenting a mixture of the starter mash, steamed vegetable(s), and water containing 300 mg/kg-1,000 mg/kg of hydrogen carbonate ions, (4) filtrating said mash in order to separate its solid and liquid parts, and (5) distilling said liquid. Milk can be used in the fermentation process.

### TECHNICAL FIELD OF THE INVENTION

The present invention relates to a method of manufacturing shochu, a traditional Japanese distilled spirit, and more particularly to shochu that has a characteristic taste and aroma.

### BACKGROUND ART

Shochu is manufactured by fermenting one or more vegetables such as rice, wheat, millet, corn, sweet potatoes, or potato buckwheat by using koji mold and yeast and then distilling the mixture.

It is well-known that the taste and aroma of shochu is greatly influenced by the type of vegetable(s) used as the raw material(s) to be fermented, the water used for fermentation, and the fermentation conditions.

Although every type of shochu has a taste, something attractive must be added to get people to choose it in competitions with various other kinds of alcoholic beverages that are available on the market. Therefore, variations and uniqueness in the taste and aroma of shochu are always desired.

Responding to these needs, some new raw materials and some new manufacturing processes for shochu have been proposed, as described in the literature; these include, for example, shochu that is made using lactic-acid bacteria that is added in the fermentation stage (Japanese Published Unexamined Patent Applications No. 060531/00), shochu that is made using cow milk that is added in the fermentation stage (Japanese Published Unexamined Patent Applications No. 132173/86, No. 108971/89, No. 17154/01), and shochu that is made using ionized alkaline water (Japanese Published Unexamined Patent Applications No. 345450/02).

### DISCLOSURE OF THE INVENTION

The objective underlying the present invention is to provide shochu that has a unique and distinguishing taste and aroma.

Accordingly, one object of the present invention is to manufacture shochu by the following steps:
1.cultivating koji mold (Aspergillus oryzae) upon and into steamed rice,
2. making starter mash by keeping a first mixture, comprising said koji mold, yeast seeds, and water containing 300 mg/kg-1,000 mg/kg of hydrogen carbonate ions, at 20° C.-35° C. for 1 day-4 days,
3. making mash by fermenting a second mixture comprising said starter mash, one or more steamed vegetables, and additional water containing 300 mg/kg-1,000 mg/kg of hydrogen carbonate ions,
4. filtrating said mash in order to separate its solid and liquid parts, and
5. distilling said liquid part.

Another objective of the present invention is to provide shochu that is made by adding milk as a part of or instead of the above-mentioned water for use in fermentation.

### BRIEF DESCRIPTION OF THE DRAWINGS

FIG. 1 is a flow chart that illustrates the general process for manufacturing shochu.

### BEST MODE FOR CARRYING OUT THE INVENTION

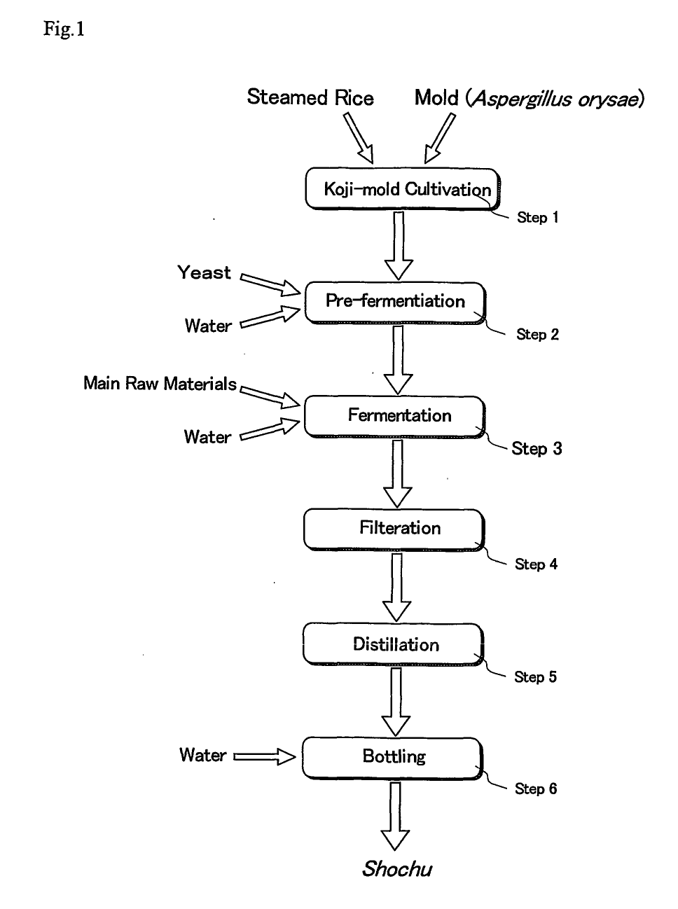

The general process for manufacturing shochu will now be described with reference to FIG. 1.

The first step is a koji-cultivating step in which spores of koji mold (Aspergillus oryzae) are sprinkled over steamed rice and cultivated upon and into the rice (Step 1).

Fermentation is carried out in two stages. The first is a pre-fermentation stage in which the koji mold and a small amount of yeast are put into water and the resulting mixture is kept at 20° C.-35° C., preferably at 25° C.-30° C., for 1 day-4 days, and preferably for 2 days-4 days (Step 2). The highest priority in making starter mash is to increase the number of yeast cells. Therefore the temperature and the length of time should be decided upon based on the extent of yeast growth that is desired.

Subsequently the main fermentation stage begins with the additions of one or more steamed vegetables and additional water to the pre-fermentation mixture so as to give a mash (Step 3). This fermentation stage typically takes 1 week to 2 weeks at 25° C.-30° C. The vegetables can be rice, wheat, millet, corn, sweet potatoes, potatoes, or buckwheat, or any combination thereof.

In manufacturing shochu, the koji mold breaks down the steamed vegetables' starch into fermentable sugars, and the yeast converts the sugars into ethanol.

After enough time has passed for the main fermentation stage to be completed, the mash is separated into its solid and liquids (Step 4). The liquid is a crude shochu, which is aged for a time, if necessary, and then is distilled under an atmospheric or vacuum conditions (Step 5).

The distilled, refined shochu, is diluted with water so as to adjust the alcohol content to a level suitable for drinking, after which it is bottled (Step 6).

As mentioned above, the vegetables are saccharized with koji mold and the saccharides in the vegetables are fermented in the presence of yeast, which chemically means that carbohydrates are biodegraded into ethanol and small amounts of other alcohols, carboxylic acids, esters, and aldehydes. Each of these minor ingredients gives the manufactured shochu a characteristic taste and aroma. The taste and aroma of the finished product depend on the constitutions of those minor ingredients, which depend on the kind of vegetables used and the fermentation conditions.

The present invention uses a specific water that contains a large amount of hydrogen carbonate ions for the fermentation. The content of the hydrogen carbonate ions in the water is 300 mg/kg-1,000 mg/kg, preferably 400 mg/kg-600 mg/kg. Negative ions other than hydrogen carbonate ions can be used in this invention although the total content of negative ions other than hydrogen carbonate ions normally is less than 200 mg/kg. However, the presence in the water of positive ions as sodium ions, potassium ions, calcium ions, magnesium ions, ammonium ions, aluminum ions, iron ions, lithium ions, barium ions, zinc ion, and manganese ions is not limited, so long as they do not have any adverse effects on the shochu of this invention. Typically positive ions in the water are 200 mg/kg-800 mg/kg of sodium ions, 30 mg/kg-400 mg/kg of potassium ions, 2 mg/kg-50 mg/kg of calcium ions, 0.1 mg/kg-20 mg/kg of magnesium ions, and less than 1 mg/kg of other ions. Water containing a large amount of hydrogen carbonate ions can be obtained naturally or by the addition of hydrogen carbonate salts such as sodium hydrogen carbonate, potassium hydrogen carbonate, or calcium hydrogen carbonate.

The presence of hydrogen carbonate ions in the water has a great effect on the fermentation products, the amount of each of the products, and their composition. The fermentation products are, as mentioned above, alcohols, carboxylic acids, esters, aldehydes, and other products, all of which deeply affect the taste and aroma of the shochu. Typical products are described below in the subsection entitled “Example 2.”

The shochu of the present invention is manufactured in the usual way, except that the water that is used contains a specified content of hydrogen carbonate ions as a result of the pre-fermentation and main fermentation processes. Also, water that contains hydrogen carbonate ions can be used for the dilution water used to adjust the alcohol content of the finished product.

The present invention can utilize milk as a part of or instead of the water that is added in the main fermentation step. The milk can be cow milk, goat milk, ewe milk, or any blend thereof The amount of milk should be less than 1.5 times the weight—preferably 0.5-1.0 times the weight—of the total amount of water added in the pre-fermentation and main fermentation stages. If the amount of milk exceeds 1.5 times the weight of the water, the taste and aroma of the finished shochu can be unsatisfactory. The milk is added before the main fermentation substantially starts.

The additions of milk in the fermentation process slightly changes the activities of the yeast, due to the presence of the animal fats and protein contained in milk. The additions of milk sometimes has an adverse effect on the taste and aroma., as noted above The literature of Japanese Published Unexamined Patent Applications No. 108971/89, for example, indicates that pH adjustment and heat sterilization in the process are necessary in order to prevent the taste and aroma to be deteriorated due to the decomposition of the milk. The present invention, in contrast, can bring out a distinct taste and aroma to the shochu by using milk with a specified water for the fermentation. This unique aroma is one of characteristic features that differentiates the shochu of this invention from other conventional shochu that is available on the market.

### EXAMPLES

The following examples are presented to indicate the preferred embodiments and utility of the invention, and the examples are not intended to limit the invention unless otherwise stated in the claims appended hereto.

### Example 1

The shochu of this example was manufactured in the conventional way except that specific water containing a large amount of hydrogen carbonate ions was used in the fermentation. For this example, 100 kg of koji mold, a small amount of yeast, and 150 kg of water that contained 500.4 mg/kg of hydrogen carbonate ions were put into a tank, mixed well, and kept at 20° C.-25° C. for 3 days in order to make a starter mash. Then 400 kg of steamed rice and 300 kg of the same quality of water as mentioned above were added to the starter mash, mixed well, and kept at 25° C.-33° C. for 10 days. After filtration, the liquid was distilled. The distillate contained approximately 40% alcohol, and it was diluted with water to 25% alcohol. Table 1 shows the types and amounts of ions in the water of this example.

TABLE 1
Ions Composition of the Water Used for Example 1

| Type of Ions | Formula | Amount Used |
|---|---|---|
| Hydrogen carbonate ions | (HCO³⁻) | 500.4 mg/kg |
| Sodium ions | (Na⁺) | 250.5 mg/kg |
| Potassium ions | (K⁺) | 51.4 mg/kg |
| Calcium ions | (Ca⁺) | 5.6 mg/kg |
| Magnesium ions | (Mg⁺) | 0.6 mg/kg |
| Aluminum ions | (Al⁺) | 0.1 mg/kg |

The taste and aroma of the shochu that was obtained were evaluated by 15 judges, all of whom were alcoholic-beverage specialists. They concluded that the shochu was as fruity as if it were a fruits wine or made from fruits. This clearly differentiates the product of this invention from conventional shochu.

### Example 2

To the same starter mash as described above for use in Example 1, there was added 400 kg of steamed rice, 300 kg of the same water used in Example 1, and 400 kg of milk. The mixture was kept at 25° C.-33° C. for 8 days for fermentation. The judges rated the aroma of the shochu obtained in this example as superior to that of the shochu of Example 1. In addition, the minor ingredients of said shochu were analyzed by gas-chromatography. The results of that analysis are shown by Table 2.

TABLE 2
Minor Ingredients (ppm) in the Shochu of Example 2
and in Three Other Shochu Products on the Market

| | Shochu of | | | |
|---|---|---|---|---|
| | the Present | | | |
| | invention | Product A | Product B | Product C |
| Acetaldehyde | 20.005 | 10.622 | 13.486 | 15.885 |
| Ethyl acetate | 52.258 | 47.287 | 53.017 | 54.319 |
| Isobutyl acetate | 0.355 | 0.366 | 0.512 | 0.552 |
| n-Propyl alcohol | 256.589 | 126.195 | 125.522 | 135.001 |
| Isobutyl alcohol | 198.897 | 211.253 | 223.012 | 184.785 |
| Isoamyl acetate | 4.768 | 9.643 | 10.470 | 11.710 |
| Isoamyl alcohol | 575.135 | 418.170 | 420.544 | 362.043 |
| Ethyl caproate | 7.473 | 0.433 | 0.580 | 0.687 |
| β-Phenethyl Alcohol | 70.128 | 26.114 | 48.756 | 22.569 |
| Ethyl caprylate | 0.080 | 0.006 | 0.013 | 0.013 |
| Ethyl caprate | 0.049 | — | 0.002 | 0.002 |
| β-Phenethyl acetate | 0.053 | 0.049 | 0.071 | 0.023 |
| Ethyl laurate | — | — | 0.001 | 0.007 |
| Ethyl myristate | — | — | — | 0.003 |

The results confirmed that the shochu of this example contained a larger much amount of ethyl caproate, β-phenethyl alcohol, ethyl caprylate, and ethyl caprate than did Shochu A, Shochu B, and Shochu C, which were shochu products available on the market, and which were manufactured from the same raw materials as in the present invention's shochu, except for the water. These ingredients are regarded as characteristic of the shochu of the present invention.

### Example 3

The shochu of Example 3 was manufactured by the same procedure as that of Example 2, except that steamed sweet potatoes were used instead of rice for the main fermentation stage. The shochu obtained had a unique aroma that is distinguishable from that of conventional shochu.

### INDUSTRIAL APPLICABILITY

The present invention has an unique aroma regardless of the method of making it, which differs little from the method of making standard shochu, and the aroma can differentiate this shochu from other shochu products, and the shochu of the present invention is unique among many shochu products.

What is claimed is:

1. A shochu manufacturing method that consists of the following steps:
(a) cultivating koji mold (Aspergillus oryzae) upon and into steamed rice;
(b) making starter mash by keeping a first mixture, which consists of said koji mold, yeast seeds, and water that contains 300 mg/kg-1,000 mg/kg of hydrogen carbonate ions, at 20° C.-35° C. for 1 day-4 days;
(c) making mash by fermenting a second mixture, which consists of said starter mash, one or more steamed vegetables, and additional water containing 300 mg/kg-1,000 mg/kg of hydrogen carbonate ions;
(d) filtrating said mash in order to separate its solid and liquid parts; and
(e) distilling said liquid.

2. Shochu according to claim 1, but wherein said vegetable(s) is/are selected from a group that consists of rice, wheat, millet, corn, sweet potatoes, potatoes, and buckwheat, or is any combination thereof.

3. Shochu according to claim 1, but wherein milk is added to said second mixture as a part of or instead of the water containing 300 mg/kg-1,000 mg/kg of hydrogen carbonate ions.

4. Shochu according to claim 3, but wherein said milk is selected from a group consisting of cow milk, goat milk, ewe milk, or is any combination thereof

5. Shochu according to claim 3, but wherein the amount of said milk is less than 1.5 times the weight of the total amount of water added to said first mixture and said second mixture.
